(19) United States
(12) Patent Application Publication
(10) Pub. No.: US 2022/0211047 A1
(43) Pub. Date: Jul. 7, 2022

(54) Broad Spectrum Biopesticides Comprising Beneficial Microorganisms

(71) Applicant: Locus Agriculture IP Company, LLC, Solon, OH (US)

(72) Inventors: Sean FARMER, Ft. Lauderdale, FL (US); Ken ALIBEK, Solon, OH (US); Paul S ZORNER, Encinitas, CA (US); Samal IBRAGIMOVA, Solon, OH (US)

(21) Appl. No.: 17/604,882

(22) PCT Filed: Apr. 20, 2020
(86) PCT No.: PCT/US2020/028979

§ 371 Date: Oct. 19, 2021

Related U.S. Application Data
(60) Provisional application No. 62/838,495, filed on Apr. 25, 2019.

(51) Int. Cl. A01N 63/27; A01N 63/22; A01N 63/20; A01N 63/38; A01N 63/30; A01N 63/32; A01N 63/50; A01N 25/12; A01P 1/00; A01P 3/00

(52) U.S. Cl. CPC A01N 63/27; A01N 63/22; A01N 63/20; A01N 63/38; A01P 3/00; A01N 63/32; A01N 63/50; A01N 25/12; A01P 1/00; A01N 63/30

(57) ABSTRACT

The subject invention provides biopesticide compositions and their use in controlling a broad spectrum of pests, including arthropods, bacteria, fungi, viruses, protozoa, parasites, nematodes, and/or pests that act as disease vectors. The compositions of the subject invention utilize beneficial microorganisms to target one or more pests that cause harm and/or damage to humans, animals, plants, and/or man-made structures, such as homes. In certain embodiments, the compositions comprise at least one species of entomopathogenic fungus.

### CROSS-REFERENCE TO RELATED APPLICATION

This application claims priority to U.S. Provisional Patent Application No. 62/838,495, filed Apr. 25, 2019, which is incorporated herein by reference in its entirety.

### BACKGROUND OF THE INVENTION

In the agriculture industry, infections and infestations caused by bacteria, fungi, and other pests and pathogens hinder the ability of farmers to maximize production yields while keeping costs low. Growers have relied heavily on the use of synthetic chemical pesticides to protect crops against pathogens, pests, and disease; however, when overused or improperly applied, these substances can pollute air and water through runoff, leaching and evaporation.

Even when properly used, the over-dependence and long-term use of certain chemical pesticides can alter soil ecosystems, reduce stress tolerance, increase pest resistance, and impede plant and animal growth and vitality. Furthermore, the use of pesticides not only risks the contamination of the environment or agricultural products, but can be harmful to humans and may unintentionally harm beneficial species.

Additionally, some antibiotics, such as oxytetracycline and streptomycin, have been approved in some areas for use in controlling bacterial pests. These antibiotics can treat certain bacterial diseases, but their use in such large quantities is worrisome to some who believe these substances will infiltrate into the products grown for consumption and/or contribute to antibiotic resistance.

Mounting regulatory mandates that govern the availability and use of chemicals and/or antibiotics, as well as consumer demands for residue free, sustainably-grown food produced with minimal harm to the environment, are impacting the pest-control industry and causing an evolution of thought regarding how to address the myriad of challenges. The demand for safer pesticides and alternate pest control strategies is increasing. While wholesale elimination of chemicals is not feasible at this time, farmers are increasingly embracing the use of biological measures as viable components of Integrated Nutrient Management and Integrated Pest Management programs.

For example, biological agents are emerging as an alternative to chemical pesticides, where live microbes, bio-products derived from microbes, and combinations thereof are used instead. These biological pesticides have important advantages over other conventional pesticides. For example, they are less harmful compared to the conventional chemical pesticides, and they are more efficient and specific. Additionally, they often biodegrade quickly, leading to less environmental pollution.

The economic costs and the adverse health and environmental impacts of current methods of crop production continue to burden the sustainability and efforts of producing food and other crop-based consumer products. Environmental awareness and consumer demand has promoted the search for improved products for pest control and their use in the treatment of agricultural crops, gardens and lawns.

Thus, there is an increasing need for improved pesticidal materials and technologies that are effective for controlling pests and preventing and/or reducing the damage and/or diseases they cause.

### BRIEF SUMMARY

The subject invention provides pesticidal compositions and methods of using these compositions to control a broad spectrum of pests, including, for example, arthropods, bacteria, fungi, viruses and/or nematodes. Advantageously, the compositions and methods of the subject invention are environmentally-friendly, non-toxic and cost-effective.

In preferred embodiments, the subject invention provides biopesticide compositions for controlling a broad spectrum of pests, wherein the composition comprises one or more beneficial microorganisms and/or growth products thereof. In certain preferred embodiments, at least one of said one or more microorganisms is an entomopathogenic fungus.

In specific embodiments, the entomopathogenic fungus is a Metarhizium spp., a Beauveria spp. and/or a Paecilomyces spp. fungus. In preferred embodiments, the Metarhizium spp. is M anisopliae.

The subject composition can also comprise one or more other microorganisms, including yeasts, fungi, and/or bacteria. For example, in some embodiments, the composition comprises one or more non-entomopathogenic fungi (e.g., Trichoderma spp.), yeasts (e.g., Debaryomyces spp., Pichia spp., Wickerhamomyces spp. and/or Meyerozyma spp.), and/or bacteria (e.g., Bacillus spp., myxobacteria, Pseudomonas spp., and/or Azotobacter spp.).

Advantageously, the combination of microorganisms in the biopesticide composition can be tailored to a particular pest and/or pests to be controlled, depending upon, for example, the pesticidal capabilities of each microorganism, the compatibility with other pesticidal microorganisms, and/or the plant/environment to be treated. Accordingly, the composition can be used to control more than one type of pest (e.g., arthropods, bacteria, fungi, nematodes and/or viruses) contemporaneously.

In one embodiment, the microorganisms used in the biopesticide composition are cultivated using solid state fermentation (SSF) and/or hybrid SSF-submerged fermentation. In certain embodiment, the biopesticide composition can comprise the fermentation medium in which the microorganism was cultivated, as well as any growth by-products produced by the microorganism and/or any residual nutrients. The microbes can be live or inactive, although in preferred embodiments, they are live.

In one embodiment, the biopesticide composition comprises chitinase and/or a chitinase inducer such as, for example, purified, or essentially pure, chitin and/or silkworm crystals. Silkworm crystals can be obtained from, e.g., the silk production parts (e.g., glands, ducts, spinners) of a silkworm such as, e.g., Bombyx mori, which can contain chitin and/or other chitin components. According to the subject invention “essentially pure” can mean about, for example, 80% purity or greater.

In one embodiment, the biopesticide composition comprises an abrasive substance. The abrasive substance can be, for example, a powder having a particle size of 1 micrometer to 1 millimeter, preferably from 10 to 200 micrometers. In one embodiment, the abrasive substance comprises pumice powder and/or diatomaceous earth (e.g., 70 to 90% silica content).

In one embodiment, the biopesticide composition can further comprise an anticoagulant substance. In preferred embodiments, the anticoagulant substance is a hemolymph anticoagulant selected from ascorbic acid, phenylthiourea and/or a combination thereof.

In some embodiments, the biopesticide composition comprises one or more growth by-products of the one or more microorganisms. The growth by-products can include, for example, biosurfactants, enzymes, toxins, acids, solvents, gases, antibiotics and/or other metabolites. The growth by-products can be added to the composition in purified form, and/or they can be present in the composition as a product of the growth of the one or more microorganisms.

In a specific embodiment, the one or more growth by-products comprise one or more biosurfactants selected from, for example, glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), fatty acid esters, flavolipids, phospholipids (e.g., cardiolipins), lipoproteins, lipopolysaccharide-protein complexes, and polysaccharide-protein-fatty acid complexes.

The composition can comprise one or more biosurfactants at a concentration of, for example, 0.0001% to 10%, 0.001% to 5%, 0.01% to 2%, and/or from 0.1% to 1%.

In some embodiments, the biosurfactants have direct pesticidal activity. In some embodiments, the biosurfactants help stimulate a plant's defense mechanisms by activating the genes that correspond to the plant's innate immune system.

In one embodiment, the subject invention provides methods for controlling one or more pests wherein one or more beneficial microorganisms and/or growth by-products thereof, are contacted with the pest(s). In preferred embodiments, the method comprises contacting a biopesticide composition according to the embodiments of the subject invention with the pest(s).

In certain embodiments, at least one of the one or more microorganisms is an entomopathogenic fungus, preferably, a Metarhizium spp. fungus. In some embodiments, the one or more microorganisms are other beneficial (non-entomopathogenic) fungi, yeasts and/or bacteria.

In certain embodiments, the method further comprises contacting chitinase and/or a chitinase inducer, an abrasive substance, and/or one or more anticoagulant substances with the pest(s).

In some embodiment, the method further comprises contacting one or more microbial growth by-products with the pest(s). The growth by-products can include, for example, biosurfactants, enzymes, toxins, acids, solvents, gases, antibiotics and/or other metabolites.

In certain embodiments, “contacting” a pest with a composition comprises directly and/or indirectly exposing the pest to the composition such that the composition can have the desired (i.e., pesticidal) effect on the pest.

In one embodiment, the method comprises applying the composition directly to the pest. In another embodiment, the method comprises applying the composition to a surface upon which the pest may traverse, rest, settle, mate, lay eggs and/or feed. The surface may be, for example, a man-made surface, such as a fence, wall, or other piece of stationary agricultural or horticultural equipment. The surface may have an attractant and/or bait component, for example, a certain color, scent or other physical or chemical signal that is attractive to a specific pest, which lures the pest towards the biopesticide composition.

In certain preferred embodiments, the surface is soil, a plant, or a plant part. The biopesticide compositions can be contacted with any part of the plant, for example, leaves, roots, seeds, stems, flowers, or fruits. Furthermore, the biopesticide compositions can be contacted with an entire plant.

The pests can be, for example, arthropods, fungi, bacteria, viruses, nematodes, protozoa, worms, and/or others that may cause harm, damage and/or disease to animals, plants and/or homes. The pest can be at any stage of life, including, where applicable, egg, pupae, nymph and/or adult.

In one embodiment, the pest is a disease vector, for example, Asian citrus psyllid, which carries a bacterial infection that causes citrus greening disease (Candidatus Liberibacter spp.). Thus, the subject method can be used for preventing, reducing and/or eliminating infection and/or spread of disease through the control of disease vector pests.

In one embodiment, the pest is a social insect, characterized by its membership in a structured colony or group comprising a plurality of members of the same species. Advantageously, when one member of the colony or group is contacted with a composition of the subject invention, it will spread the microorganism(s) and/or other components of the composition, along to other members of the colony with which it interacts, thereby controlling those other members.

In certain embodiments, the methods of the subject invention can further comprise testing a site for the presence of a pest and/or signs of a pest's presence. Based on what pest(s) are detected, the method can comprise producing a customized biopesticide composition to control the full spectrum of those pests. In other words, the combination of microorganisms, growth by-products, and other ingredients in the biopesticide composition can be tailored to a particular pest and/or pests to be controlled, depending upon, for example, the pesticidal capabilities of each microorganism and/or ingredient, compatibility with other pesticidal microorganisms, and/or the plant/environment to be treated. Accordingly, the methods can be used to control more than one type of pest contemporaneously.

Advantageously, the subject invention is useful for protecting animals, plants or plant parts from, for example, settling, biting, egg-laying and/or feeding thereon by an insect. Advantageously, the method can protect plants from damage and/or death as a result of microbial pests. The subject invention is also useful for protecting agricultural crops from infestation, water loss, viral/microbial infection and/or combinations thereof. Even further, the subject invention can be used for reducing nuisance pests in the home, lawn or garden.

Advantageously, the present invention can be used without releasing large quantities of inorganic compounds into the environment. Additionally, the subject compositions and methods utilize components that are biodegradable and toxicologically safe.

### DETAILED DESCRIPTION

The subject invention provides pesticidal compositions and methods of using these compositions to control a broad spectrum of pests, including, for example, arthropods, bacteria, fungi, viruses and/or nematodes. Advantageously, the compositions and methods of the subject invention are environmentally-friendly, non-toxic and cost-effective.

### Selected Definitions

As used herein, “agriculture” means the cultivation and breeding of plants, algae and/or fungi for food, fiber, biofuel, medicines, cosmetics, supplements, ornamental purposes and other industrial or commercial uses. According to the subject invention, agriculture can also include horticulture, landscaping, gardening, plant conservation, orcharding and arboriculture. Further included in agriculture are the care, monitoring and maintenance of soil.

As used herein, a “biofilm” is a complex aggregate of microorganisms, wherein the cells adhere to each other and/or to surfaces. In some embodiments, the cells produce an extracellular polysaccharide matrix to facilitate adherence. The cells in biofilms are physiologically distinct from planktonic cells of the same organism, which are single cells that can float or swim in liquid medium.

As used here in, a “biologically pure culture” is one that has been isolated from materials with which it is associated in nature and/or in which it is produced. In a preferred embodiment, the culture has been isolated from all other living cells and/or other materials. In further preferred embodiments, the biologically pure culture has advantages characteristics compared to a culture of the same microbe as it exists in nature and/or in association with other materials. The advantageous characteristics can be, for example, enhanced production of one or more by-products of their growth.

As used herein, the term “control” used in reference to a pest refers to the act of killing, disabling, immobilizing, or reducing population numbers of a pest, or otherwise rendering the pest substantially incapable of reproducing and/or causing harm. Accordingly, “pesticidal” means capable of controlling a pest, and a “pesticidally-effective” amount of a substance is an amount that is capable of pesticidal action.

As used herein, an “isolated” or “purified” molecule or substance, is substantially free of other compounds, such as cellular material, with which it is associated in nature and/or in which it is produced. A purified or isolated polynucleotide (ribonucleic acid (RNA) or deoxyribonucleic acid (DNA)) is free of genes or sequences that flank it in its naturally-occurring state. A purified or isolated polypeptide is free of the amino acids or sequences that flank it in its naturally-occurring state. An “isolated” microbial strain means that the strain is removed from the environment in which it exists in nature and/or in which it was produced. Thus, the isolated strain may exist as, for example, a biologically pure culture, or as spores (or other forms of the strain).

In certain embodiments, purified compounds are at least 60% by weight the compound of interest. Preferably, the preparation is at least 75%, more preferably at least 90%, and most preferably at least 99%, by weight the compound of interest. For example, a purified compound is one that is preferably at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. Examples of metabolites include, but are not limited to, biopolymers, enzymes, acids, solvents, alcohols, proteins, vitamins, minerals, microelements, amino acids, carbohydrates and biosurfactants.

As used herein, the term “plurality” refers to any number or amount greater than one.

As used herein, “reduce” refers to a negative alteration, and the term “increase” refers to a positive alteration, of at least (positive or negative) 1%, 5%, 10%, 25%, 50%, 75%, or 100%.

As used herein, “surfactant” refers to a compound that lowers the surface tension (or interfacial tension) between two phases. Surfactants act as, e.g., detergents, wetting agents, emulsifiers, foaming agents, and dispersants. A “biosurfactant” is a surfactant produced by a living organism.

As used herein, a plant's “surrounding environment” means the soil and/or other medium in which the plant is growing, which can include the rhizosphere. In certain embodiments, the surrounding environment does not extend past, for example, a radius of 100 feet, 10 feet, 8 feet, or 6 feet from the plant.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19, or 20 as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The description herein of any aspect or embodiment of the invention using terms such as “comprising,” “having,” “including” or “containing” with reference to an element or elements is intended to provide support for a similar aspect or embodiment of the invention that “consists of,” “consists essentially of,” or “substantially comprises” that particular element or elements, unless otherwise stated or clearly contradicted by context. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood to be within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references referred to or cited herein are incorporated by reference in their entirety, including all figures and tables, to the extent they are not inconsistent with the explicit teachings of this specification.

### Biopesticide Compositions

The subject invention provides microbe-based biopesticide compositions for controlling a broad spectrum of pests, and for protecting humans, plants and animals from harm due to pests.

As used herein, reference to a “microbe-based composition” means a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In some embodiments, the microbes are present, with medium in which they were grown, in the microbe-based composition. The cells may be present at, for example, a concentration of at least 1×10⁴, 1×10₅, 1×10⁶, 1×10⁷, 1×10⁸, 1×10⁹, 1×10¹⁰, 1×10¹¹, 1×10¹² or 1×10¹³ or more CFU per milliliter of the composition.

In preferred embodiments, the biopesticide compositions comprise one or more beneficial microorganisms and/or growth products thereof. In certain preferred embodiments, at least one of said one or more microorganisms is an entomopathogenic fungus (EF).

EF are parasitoid fungi that can cause disease and/or death in arthropods and other pests that they infect. They are found naturally in soils worldwide, and belong to a number of different taxa from several fungal groups. Many of these fungi are considered natural control agents and are environmentally safe, making them ideal for use as biological control agents against insects and other arthropod pests, as well as certain nematodes, in various outdoor applications.

In certain embodiments, the EF of the subject composition are also capable of producing pesticidal growth by-products that can be used for controlling other, non-arthropod pests as well.

In certain embodiments, the entomopathogenic fungus can include Beauveria spp. (e.g., B. bassiana, B. brongniartir), Cordyceps spp. (e.g., C., gracilis, C. ishikariensis, C. sinensis), Entomophaga spp. (e.g. E. maimaiga), Entomophthora spp. (e.g., E. muscae), Hirsutella spp. (e.g., H. thompsonii, H. gigantea, H. citriformis), Isaria (or Paeciomyces) spp. (e.g., P. cicadae, P. farinosus, P. fiunosoroseus, P. lilacinus), Lecanicillium spp. (e.g., L. lecani, L. muscarium), Metarhizium spp. (e.g., M anisopliae, M brunneum, M. cicadinum, M cylindrosporum, M flavoviride, M taii, M truncatum, M. viridicolumnare), Nomuraea spp. (e.g., N. rileyi), Pandora spp. (e.g., P. neoaphidis), Purpureocillium spp. (e.g., P. ilacinum) and/or Zoophthora spp. (e.g., Z. radicans).

In preferred embodiments, the entomopathogenic fungus is a Metarhizium spp., even more preferably, M. anisopliae.

In one embodiment, the entomopathogenic fungi are in the form of conidia. Conidia are asexual fungal spores, which are tolerant to high temperatures, relatively stable under different environmental conditions and can be quantified and used as units of measurement to evaluate parameters such as fungi viability and lethal dose (LD₅₀).

The term “LD₅₀” means the median lethal dose of entomopathogenic fungus that kills 50% of the pests receiving that dose and is measured in number of conidia. The LD₅₀ can be determined with respect to a group of pests in a laboratory bioassay. The bioassay can be performed by making serial dilutions of the fungus and applying several times an individually known amount to a group of pests and monitoring the daily mortality.

Most entomopathogenic fungi initiate infection by germinating the spores (conidia) that adhere and penetrate the cuticle of the host pest. High humidity is usually required for sporulation. In the case of an arthropod pest, for example, the fungus penetrates the pest's cuticle, and the invasive hyphae penetrate host tissues and spread through the body cavity (haemocoele). The bodies or segments of the hyphae are distributed throughout the haemocoele, filling the dying pest with mycelia. Hyphae appear through the pest's integument and produce spores on the external surface of the host. Typically, the pest is eventually killed (sometimes by toxins secreted by the fungus) and new spores are formed in or on the pest (if humidity and temperature are ideal).

In some embodiments, the concentration of each species of entomopathogenic fungus in the composition is about 1×10⁶ to about 1×10¹², about 1×10⁷ to about 1×10¹¹, about 1×10⁸ to about 1×10¹⁰, or about 1×10⁹ conidia/mL.

In certain embodiments, the biopesticide composition comprises one or more other microorganisms, including yeasts, (non-entomopathogenic) fungi, and/or bacteria.

In one embodiment, the other microorganism is a yeast or fungus. Yeast and fungus species suitable for use according to the current invention, include Aspergillus spp, Auerobasidium (e.g., A. pullulans), Blakeslea, Candida (e.g., C. apicola, C. bombicola, C. nodaensis), Cryptococcus, Debaryomyces (e.g., D. hanseni), Entomophthora, Hanseniaspora, (e.g., H. uvarum), Hansenula, Issatchenkia, Kluyveromyces (e.g., K. phafi), Meyerozyma spp. (e.g., M. guilliermondii), Mortierella, mycorrhizal fungi, Phycomyces, Pichia (e.g., P. anomala, P. guilliermondii, P. occidentalis, P. kudriavzevii), Pleurotus spp. (e.g., P. ostreatus), Pseudozyma (e.g., P. aphidis), Saccharomyces (e.g., S. boulardii, S. cerevisiae, S. torula), Starmerella (e.g., S. bombicola), Torulopsis, Trichoderma (e.g., T. reesei, T. harzianum, T. hamatum, T. viride), Wickerhamomyces (e.g., W. anomalus), Williopsis (e.g., W. mrakii), Zygosaccharomyces (e.g., Z. baidii), and others.

In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquefaciens, B. amyloliquefaciens NRRL B-67928, B. circulans, B. firmus, B. laterosporus, B. lichenmformis, B. megaterium, B. mucilaginosus, B. subtilis), Frateuria (e.g., F. aurantia), Microbacterium (e.g., M. laevanmformans), myxobacteria (e.g., Myxococcus xanthus, Stignatella aurantiaca, Sorangium cellulosum, Minicystis rosea), Pantoea (e.g., P. agglomerans), Pseudomonas (e.g., P. chlororaphis subsp. aureofaciens (Kluyver), P. putida), Rhizobium spp., Rhodospirillum (e.g., R. rubrum), Sphingomonas (e.g., S. paucimobilis), and/or Thiobacillus thiooxidans (Acidothiobacillus thiooxidans).

In a specific embodiment, the one or more other microbes include Pseudomonas chlororaphis, Debaryomyces hansenii, Wickerhamomyces anomalus, Starmerella bombicola, Saccharomyces boulardii, Pichia occidentalis, Pichia kudriavzevii, and/or Meyerozyma guilliermondii.

Advantageously, the combination of microorganisms in the biopesticide composition can be tailored to a particular pest and/or pests to be controlled, depending upon, for example, the pesticidal capabilities of each microorganism, the compatibility with other pesticidal microorganisms, and/or the plant/environment to be treated. Accordingly, the composition can be used to control more than one type of pest (e.g., arthropods, bacteria, fungi, nematodes and/or viruses) contemporaneously.

In one embodiment, the microorganisms used in the biopesticide composition are cultivated using solid state fermentation (SSF) and/or hybrid SSF-submerged fermentation. In certain embodiment, the biopesticide composition can comprise the fermentation medium in which the microorganism was cultivated, as well as any growth by-products produced by the microorganism and/or any residual nutrients. The microbes can be live or inactive, although in preferred embodiments, they are live.

In one embodiment, the biopesticide composition comprises chitinase and/or a chitinase inducer such as, for example, purified, or essentially pure, chitin and/or silkworm crystals. Silkworm crystals can be obtained from, e.g., the silk production parts (e.g., glands, ducts, spinners) of a silkworm such as, e.g., Bombyx mori, which can contain chitin and/or other chitin components. According to the subject invention “essentially pure” can mean, for example, about 80% purity or greater.

Chitinase is an enzyme produced by certain EF and other microbes, which helps degrade chitin, a polysaccharide substance that makes up a large portion of the exoskeleton of arthropods, as well as the cell walls of certain fungi. The inclusion of chitin and/or a chitinase inducer enhances the production of chitinase by the entomopathogenic fungus/fungi and/or other microbes of the biopesticide composition, thereby enhancing their potential virulence against pests.

In one embodiment, the biopesticide composition comprises an abrasive substance. In preferred embodiments, the abrasive substance is in the form of a powder having a particle size of 1 micrometer to 1 millimeter, preferably from 10 to 200 micrometers. Preferably, the abrasive substance is pumice powder and/or diatomaceous earth. In a specific embodiment, the diatomaceous earth has a silica content of 70 to 90%.

Diatomaceous earth comprises fossilized remains of a type of hard-shelled protest known as diatoms. Microscopically, the particles are very sharp and can stick to an insect, becoming lodged between its exoskeletal joints. As the insect moves, its body receives cuts and lacerations from the sharp particles. Furthermore, the abrasive particles can scratch away at the insect's waxy exoskeletal layer, which then allows internal moisture to escape from the insect's body. The moisturized surface of the insect and the “bleeding” liquids from the circulatory system due to the cuts allow germination of fungal spores, thus increasing the propagation of the fungi and hastening the death of the insect.

In one embodiment, the biopesticide composition can further comprise an anticoagulant substance. In preferred embodiments, the anticoagulant substance is a hemolymph anticoagulant selected from ascorbic acid, phenylthiourea and/or a combination thereof. The addition of the anticoagulant prevents the coagulation of the pest's hemolymph after exposure to the abrasive substance. Preferably, 0.001% up to 0.1% of one or both of ascorbic acid and phenylthiourea can be used.

In some embodiments, the biopesticide composition comprises one or more growth by-products of the one or more microorganisms. In preferred embodiments, the one or more growth by-products are bioactive compounds that are effective for controlling one or more types of pests. The growth by-products can include, for example, biosurfactants, enzymes, toxins, acids, solvents, gases, biopolymers, antibiotics and/or other metabolites. The growth by-products can be added to the composition in purified form, and/or they can be present in the composition as a product of the growth of the one or more microorganisms.

In certain embodiments, the growth by-products are biosurfactants or a blend of more than one type of biosurfactant. Biosurfactants are a structurally diverse group of surface-active substances produced by microorganisms. Biosurfactants are biodegradable and can produced using selected organisms in or on renewable substrates.

All biosurfactants are amphiphiles. They consist of two parts: a polar (hydrophilic) moiety and non-polar (hydrophobic) group. Due to their amphiphilic structure, biosurfactants increase the surface area of hydrophobic water-insoluble substances, increase the water bioavailability of such substances, and change the properties of bacterial cell surfaces. Furthermore, biosurfactants accumulate at interfaces, and reduce the surface and interfacial tension between the molecules of liquids, solids, and gases, thus leading to the formation of aggregated micellar structures in solution.

Biosurfactants according to the subject invention include, for example, glycolipids, lipopeptides, fatty acid ester compounds, fatty acid ether compounds, flavolipids, phospholipids, lipoproteins, lipopolysaccharide-protein complexes, and/or polysaccharide-protein-fatty acid complexes.

In one embodiment, the biosurfactants can comprise one or more glycolipids such as, for example, rhamnolipids, rhamnose-d-phospholipids, trehalose lipids, trehalose dimycolates, trehalose monomycolates, mannosylerythritol lipids, cellobiose lipids, ustilagic acid and/or sophorolipids (including lactonic and/or acidic forms).

In one embodiment, the biosurfactants can comprise one or more lipopeptides, such as, for example, surfactin, iturin, fengycin, arthrofactin, viscosin, amphisin, syringomycin, and/or lichenysin.

In one embodiment, the biosurfactants can comprise one or more other types of biosurfactants, such as, for example, cardiolipin, emulsan, lipomanan, alasan, and/or liposan.

In one embodiment, the biosurfactants can comprise one or more microbial-produced fatty acid ester compounds having physical properties and/or behaviors similar to those of biosurfactants, but which are not commonly known as biosurfactants. In certain embodiments, the fatty acid ester compounds can include, for example, highly esterified oleic fatty acids, such as oleic fatty acid ethyl esters and/or oleic fatty acid methyl esters (FAME).

According to embodiments of this invention, biosurfactants enhance the biopesticide composition because they are able to penetrate through the cells and/or tissue of pests, serving as adjuvants as well as active pesticidal ingredients. In some embodiments, the biosurfactants can serve as adjuvants that enhance the effectiveness of other pesticidal (including fungicidal, viricidal and herbicidal) compounds. Furthermore in some embodiments, the biosurfactants can have an indirect pesticidal effect by stimulating the genes that activate a plant's defense/immune system.

The biopesticide composition can comprise one or more biosurfactants at a concentration of, for example, 0.001% to 10%, 0.01% to 5%, 0.05% to 2%, and/or from 0.1% to 1%. In preferred embodiments, the concentration of biosurfactants is at or above the critical micelle concentration (CMC).

In certain embodiments, the one or more growth by-products include enzymes, such as, for example, oxidoreductases, transferases, hydrolases, lyases, isomerases and/or ligases. Specific types and/or subclasses of enzymes according to the subject invention can also include, but are not limited to, nitrogenases, proteases, amylases, glycosidases, cellulases, glucosidases, glucanases, galactosidases, moannosidases, sucrases, dextranases, hydrolases, methyltransferases, phosphorylases, dehydrogenases (e.g., glucose dehydrogenase, alcohol dehydrogenase), oxygenases (e.g., alkane oxygenases, methane monooxygenases, dioxygenases), hydroxylases (e.g., alkane hydroxylase), esterases, lipases, ligninases, mannanases, oxidases, laccases, tyrosinases, cytochrome P450 enzymes, peroxidases (e.g., chloroperoxidase and other haloperoxidases), lactases, chitinases and/or killer yeast toxins (e.g., exo-β-1,3-glucanase, KT1, KT28).

In certain embodiments, the one or more growth by-products include antibiotic compounds, such as, for example, aminoglycosides, amylocyclicin, bacitracin, bacillaene, bacilysin, bacilysocin, corallopyronin A, difficidin, etnangien gramicidin, β-actams, licheniformin, macrolactinsublancin, oxydifficidin, plantazolicin, ripostatin, spectinomycin, subtilin, tyrocidine, and/or zwittermicin A.

In certain embodiments, the one or more growth by-products include anti-fungal compounds, such as, for example, fengycin, surfactin, haliangicin, mycobacillin, mycosubtilin, and/or bacillomycin. In some embodiments, an anti-fungal can also be a type of biosurfactant.

In certain embodiments, the one or more growth by-products include other bioactive compounds, such as, for example, butanol, ethanol, acetate, ethyl acetate, lactate, acetoin, benzoic acid, 2,3-butanediol, beta-glucan, indole-3-acetic acid (IAA), lovastatin, destruxins, beauvericins, bassinolide, efrapeptins, aurachin, kanosamine, reseoflavin, terpentecin, pentalenolactone, thuringiensin (β-exotoxin), oligosporon, phomalactone, polyketides (PKs), terpenes, terpenoids, phenyl-propanoids, alkaloids, siderophores, as well as ribosomally and non-ribosomally synthesized peptides, alkaloids, dibenzoquinone pigments and cyclodepsipeptides, to name a few.

In certain embodiments, the biopesticide composition is formulated for application to soil, seeds, whole plants, or plant parts (including, but not limited to, roots, tubers, stems, flowers and leaves). In certain embodiments, the composition is formulated as, for example, dust, granules, microgranules, pellets, wettable powder, flowable powder, emulsions, microcapsules, oils, or aerosols.

To improve or stabilize the effects of the composition, it can be blended with suitable adjuvants and then used as such or after dilution if necessary. In certain specific embodiments, the composition is formulated as a dry powder or as dry granules, which can be mixed with water and other components to form a liquid product.

In one embodiment, the biopesticide composition can be mixed with an acceptable carrier. The acceptable carrier for purposes of the present invention can be defined as a substance or mixture of substances (e.g., oils, emulsions and suspensions) capable of dispersing the active components without affecting its ability to perform its intended function. The compositions may be in the form of oil, emulsion or suspension type. The term “oil” is intended to include substances that are viscous, oily liquid at ordinary temperatures. The oils may be petroleum or vegetable. Light oils include paraffinic oils, and other petroleum-based oils and vegetable oils, such as, e.g., those derived from corn, coconut, canola, cottonseed, soybeans, sunflower seeds and palm kernel.

In some embodiments, the biopesticide composition further comprises a bait or attractant component. For example, natural or synthetic fragrances, chemo-attractants, dyes and/or other sensory attractants can be included in the composition in order to draw pests towards the composition to effectively control them. In certain embodiments, the attractant and/or bait is specific to a particular pest, control of which is desired, so as to avoid drawing in and harming beneficial species.

The biopesticide composition can further comprise natural pesticides and/or pest repellents. These can include, for example, lemon eucalyptus oil, citronella, peppermint oil, mineral oils, garlic extract, and/or chili extract.

The biopesticide composition can further comprise adherent substances, which are particularly useful for folial treatment. Adherent substances can include charged polymers or polysaccharide, such as, for example, xanthan gum, guar gum, levan, xylinan, welan gum, gellan gum, curdlan, or pullulan, which allow the composition to remain on the surfaces of plant vegetation for extended periods of time.

Advantageously, the subject invention is useful for protecting animals, plants or plant parts from, for example, settling, biting, egg-laying and/or feeding thereon by an insect. Advantageously, the method can protect plants from damage and/or death as a result of microbial pests. The subject invention is also useful for protecting agricultural crops from infestation, water loss, viral/microbial infection and/or combinations thereof. Even further, the subject invention can be used for reducing nuisance pests in the home, lawn or garden.

### Methods of Controlling Pests

In one embodiment, the subject invention provides methods for controlling one or more pests wherein one or more beneficial microorganisms and/or growth by-products thereof, are contacted with the pest(s). In preferred embodiments, the method comprises contacting a biopesticide composition according to embodiments of the subject invention with the pest(s).

In certain embodiments, at least one of the one or more microorganisms is an entomopathogenic fungus, preferably, a Metarhizium spp. fungus. In some embodiments, the method comprises contacting one or more other microorganisms, including other entomopathogenic fungi, as well as other beneficial non-entomopathogenic fungi, yeasts and/or bacteria, with the pest(s).

In certain embodiments, the method further comprises contacting chitinase and/or a chitinase inducer, an abrasive substance, and/or one or more anticoagulant substances with the pest(s).

In some embodiment, the method further comprises contacting one or more microbial growth by-products with the pest(s). The growth by-products can include, for example, biosurfactants, biopolymers, enzymes, toxins, acids, solvents, gases, antibiotics and/or other metabolites.

In certain embodiments, “contacting” a pest with a composition comprises directly and/or indirectly exposing the pest to the composition such that the composition can have the desired (i.e., pesticidal) effect on the pest.

The pests can be, for example, arthropods, fungi, bacteria, viruses, nematodes, protozoa, worms, and/or others that may cause harm, damage and/or disease to animals, plants and/or homes. The pest can be at any stage of its life cycle.

In one embodiment, the pest is a disease vector, for example, Asian citrus psyllid, which carries a bacterial infection that causes citrus greening disease (Candidatus Liberibacter spp.). Thus, the subject method can be used for preventing, reducing and/or eliminating infection and/or spread of disease through the control of disease vector pests.

In one embodiment, the pest is a social insect, characterized by its membership in a structured colony or group comprising a plurality of members of the same species. Advantageously, when one member of the colony or group is contacted with a composition of the subject invention, it will spread the microorganism(s) and/or other components of the composition, along to other members of the colony with which it interacts, thereby controlling those other members.

Advantageously, the subject invention is useful for protecting animals, plants or plant parts from, for example, settling, biting, egg-laying and/or feeding thereon by an insect. Advantageously, the method can protect plants from damage and/or death as a result of microbial pests. The subject invention is also useful for protecting agricultural crops from infestation, water loss, viral/microbial infection and/or combinations thereof. Even further, the subject invention can be used for reducing nuisance pests in the home, lawn or garden.

In one embodiment, the method comprises applying the composition directly to the pest. In another embodiment, the method comprises applying the composition to a surface upon which the pest may traverse, rest, settle, mate, lay eggs and/or feed. The surface may be, for example, a man-made surface, such as a fence, wall, or other piece of stationary agricultural or horticultural equipment. The surface may have an attractant and/or bait component, for example, a certain color, scent or other physical or chemical signal that is attractive to a specific pest, which lures the pest towards the biopesticide composition.

In certain preferred embodiments, the surface is a plant or a plant part. The biopesticide compositions can be contacted with any part of the plant, for example, leaves, roots, seeds, stems, flowers, or fruits. Additionally, the biopesticide compositions can be contacted with an entire plant. Furthermore, the biopesticide compositions can also be applied to the soil in which a plant grows, and/or the air surrounding the plant.

Plants and/or their environments can be treated at any point during the process of cultivating the plant. For example, the biopesticide composition can be applied to the plant and/or its environment prior to, concurrently with, or after the time when seeds are planted. It can also be applied at any point thereafter during the development and growth of the plant, including when the plant is flowering, fruiting, and during and/or after abscission of leaves.

In certain embodiments, the plant receiving treatment is healthy. In other embodiments, the plant is affected by a plant disease or plant disease symptom.

In one embodiment, the biopesticide composition is applied inside an insect trap having the biopesticide composition therein. Insect pests can be lured into the trap by, for example, an attractant chemical, pheromone, fragrance or visual lure. In one embodiment, the lure does not lure in advantageous insects. Then, the pest can be contacted with the biopesticide composition while inside the trap. Examples of traps that can be used according to the invention include, but are not limited to, light traps, adhesive traps, pan traps, bucket traps, bottle traps, flight interception traps, Malaise traps, pitfall traps, grain probes, spikes, subterranean bait systems and soil emergence traps.

The methods can further comprise adding materials to enhance growth of the microorganism(s) in the composition during application. In one embodiment, the growth enhancers comprise nutrient sources such as, for example, sources of nitrogen, potassium, phosphorus, magnesium, proteins, vitamins and/or carbon.

In one embodiment, the method can be used for inhibiting, preventing or reducing the spread and/or incidence of pest-borne disease, for example, in plants, humans and animals, by, for example, controlling a disease vector pest.

In one embodiment, the method is particularly useful for preventing plant disease by preventing the settling of an infected disease vector onto the plant, thereby inhibiting, preventing or reducing the transport of disease pathogens to the plant.

In one embodiment, the method can be used to control pests that are considered nuisances in the home, garden and/or lawn. For example, the biopesticide composition can be applied using, for example, a handheld sprayer, to the lawn, garden, and landscaping surrounding a home to, for example, reduce the populations of a pest that might infest such areas and/or that might enter the home undesirably.

The subject method can also be used in combination with other agricultural or horticultural plant management systems. In one embodiment, the composition can optionally comprise, or be applied with, natural and/or chemical fertilizers and/or sources of plant nutrients.

In one embodiment, the method can be used in a large scale agricultural setting. The method can comprise administering the biopesticide using an irrigation system. Thus, a plant and/or soil surrounding the plant can be treated with the biopesticide composition via, for example, soil injection, soil drenching, or using a center pivot irrigation system, or with a spray over the seed furrow, or with sprinklers or drip irrigators. Advantageously, the method is suitable for treating hundreds of acres of crops, orchards or fields at one time.

In one embodiment, the method can be used in a smaller scale setting, such as in a home garden, lawn or greenhouse. The method can comprise applying the biopesticide composition using a handheld lawn and garden sprayer having water and optionally other pesticides and nutrient sources therein.

In certain embodiments, the methods of the subject invention can further comprise testing a target site for the presence of a pest and/or signs of a pest's presence. Based on what pest(s) are detected, the method can comprise producing a customized biopesticide composition to control the full spectrum of those pests. In other words, the combination of microorganisms, growth by-products, and other ingredients in the biopesticide composition can be tailored to a particular pest and/or pests to be controlled, depending upon, for example, the pesticidal capabilities of each microorganism and/or ingredient, compatibility with other pesticidal microorganisms, and/or the plant/environment to be treated. Accordingly, the methods can be used to control more than one type of pest contemporaneously.

In one embodiment, the methods of the subject invention lead to a reduction in the number of pests at a target site by about 5%, 10%, 20%, 30%, 40%, 50%, 60% 70%, 80%, or 90% or more, compared to an untreated site.

In certain embodiments, the methods and compositions according to the subject invention reduce harm and/or damage to a plant, animal, human or manmade structure caused by pests by about 5%, 10%, 20%, 30%, 40%, 50%, 60% 70%, 80%, or 90% or more, compared with pre-treatment conditions.

In certain embodiments, the methods and compositions according to the subject invention reduce the occurrence of a disease caused by pests by about 5%, 10%, 20%, 30%, 40%, 50%, 60% 70%, 80%, or 90% or more, compared with pre-treatment conditions.

In certain embodiments, the methods and compositions according to the subject invention lead to an increase in crop yield by about 5%, 10%, 20%, 30%, 40%, 50/a, 60% 70%, 80%, or 90% or more, compared to untreated crops.

In one embodiment, the methods of the subject invention lead to an increase in the mass of a plant by about 5%, 10%, 20%, 30%, 40%, 50%, 60% 70%, 80%, or 90% or more, compared to a plant growing in an untreated environment.

### Target Pests

The subject methods can be used to control pests that can infest crops, gardens, lawns, homes, greenhouses, and the like.

As used herein, a “pest” is any organism, other than a human, that is destructive, deleterious and/or detrimental to humans or human concerns (e.g., health, pets, agriculture). Pests may cause and/or carry agents that cause infections, infestations and/or disease. Pests may cause direct harm, for example, by stinging, biting and/or eating parts of a plant. Pests may be single- or multi-cellular organisms, including but not limited to, bacteria, viruses, fungi, molds, parasites, protozoa, arthropods, nematodes and/or other plants.

In some embodiments, the pest is an arthropod, which includes insects. As used herein, the term “insect” refers to any member of a large group of invertebrate animals characterized in the adult state by division of the body into head, thorax, and abdomen, three pairs of legs, and, often (but not always) two pairs of membranous wings. This definition therefore includes, but not limited to a variety of biting/stinging insects (e.g., ants, bees, black flies, chiggers, fleas, green head flies, mosquitoes, stable flies, ticks, and wasps), Wood-boring insects (e.g., termites), noxious insects (e.g., house flies, cockroaches, lice, roaches, and wood lice), and household pests (e.g., flour and bean beetles, dust mites, moths, silverfish, bed bugs, carpet beetles, furniture beetles, book lice, clothes moths, spiders and weevils). Other examples include locusts, caterpillars, bugs, hoppers, and aphids. This definition also includes non-adult insect states include larva and pupa.

Examples of arthropod pests for which the subject invention is useful include, but are not limited to, cockroaches, grasshoppers, arachnids, termites, ants, mites, thrips, aphids, mealybugs, psyllids, soft scales, whiteflies, leathoppers, weevils, true bugs, box-elder bugs, borers, beetles, Delphacidae (e.g., Laodelphax striatellus, Nilaparvata lugens, or Sogatella furcifera); Deltocephalidae (e.g., Nephotettix cincticeps); Aphididae (e.g., Aphis gossypii, Myzus persicae, Brevicoryne brassicae, Macrosiphum euphorbiae, Aulacorthum solani, Rhopalosiphum padi); Pentatomidae (e.g., Nezara antennata, Riptortus clavetus, Leptocorisa chinensis, Eysarcoris parvus, or Halyomorpha mista); Aleyrodidae (e.g., Trialeurodes vaporariorum, Bemisia tabaci); Pyralidae (e.g., Chilo suppressalis, Tryporyza incertudas, Cnaphalocrocis medinalis, Notarcha derogata, Piodia interpunctella, Ostrinia furnacalis or Hellula undalis); Noctuidae (e.g., Spodoptera litura, Spodoptera exigua, Mythimna separata, Mamestra brassicae, Agrotis ipsilon, Plusia nigrisigna, Michoplusia spp., Heliothis spp., or Helicoverpa spp.); Pieridae (e.g., Pieris rapae); Tortricidae (e.g., Legumintvora glycinivorella, Matsumuraeses azukivora) and Yponomeutidae (e.g., Plutella rylostella); Frankliniella occidentalis, Thrips palmi, Scirtothrips dorsalis, Thrips tabaci, Frankliniella intonsa; Anthomyiidae (e.g., Delia platura, or Delia antiqua); Agromyzidae (e.g., Agromyza oryzae, Hydrellia griseola, Liriomyza sativae, Liriomyza trifolii, or Chromatomyia horticola); Chloropidae (e.g., Chlorops oryzae); Drosophilidae; Corn root worms (Diabrotica spp.) (e.g., Diabrotica virgifera virgifera, or Diabrotica undecimpunctata howardi); Scarabaeidae (e.g., Anomala cuprea, Anomala rufocuprea, or Popillia japonica); Curculionidae (e.g., Sitophilus zeamais, Lissorhoptrus oryzophilus, Echinocnemus squameus, or Anthonomus grandis); Chrysomelidae (e.g., Oulema oryzae, Aulacophora femoralis, Phyllotreta striolata, or Leptinotarsa decemlineata); Elateridae (Agriotes spp.); Paederus fuscipes; and any other that may cause damage and/or disease to plants and/or homes.

Further examples of arthropods and/or insects include psyllids such as Asian Citrus Psyllid (Diaphorina citri), an African Citrus Psyllid (Trioza erytreae), a Pear Psyllid (Cacopsyla (Psylla) pyri), a Carrot Psyllid (Trioza apicalis), a Potato Psyllid (Bactericera (Paratrioza) cockerelli), and any psyllid of the family Psyllidae; moths such as European Grapevine Moth (Lobesia botrana or EGVM), False Codling Moth (Thawnatotibia leucotreta or FCM), European Gypsy Moth (Lymantria dispar or EGM), Indian Meal Moth (Plodiainter punctella), Angoumois Grain Moth (Sitotroga cerealella), Rice moth (Corcyra cephalonica), and Light Brown Apple Moth (Epiphyas postvittana or LBAM); beetles such as Asian Longhorned Beetle (Anoplophora glabripennis, or ALB), Coconut Rhinoceros Beetle (Oryctes rhinoceros), Emerald Ash Borer beetle (Agrilus planipennis or EAB), Rust Red Flour Beetle (Tribolium spp.), Sawtooth Grain Beetle (Oryzaephilus surinamensis), Flat Grain Beetle (Cryptolestes spp.), and Khapra Beetle (Trogoderma granarium); flies such as Mediterranean Fruit Fly (Ceratitis capitata or Medfly), Mexican Fruit Fly (Anastrepha ludens), and Oriental Fruit Fly (Bactrocera dorsalis); flies, such as sand flies, horse flies, tsetse flies, deer flies and eye gnats such as Hippelates; ants such as Imported fire ants (Solenopsis invicta); and mosquitoes such as the genus Anopheles, Trypanosoma, Aedes spp. (e.g., Aedes aegypti), Culex, Mansonia, and Anopheles.

In some embodiments, the pest is a disease vector, i.e., a carrier for a pathogenic agent such as a bacteria, fungus, parasite or virus that infects humans, animals and/or plants. In one embodiment, the pest can be a mosquito that carries an agent that causes, for example, malaria, zika virus, West Nile fever, chikungunya, dengue fever, yellow fever, Japanese encephalitis, Rift Valley fever, and/or lymphatic filariasis.

In one embodiment, the pest is a fly or midge that carries an agent that causes, for example, loa loa filariasis, onchocerciasis, sandfly fever, African trypanosomiasis (sleeping sickness), and/or leishmaniasis.

In one embodiment, the pest is a bed bug that carries an agent that causes, for example, Chagas disease.

In one embodiment, the pest is a louse or flea that carries an agent that causes, for example, bartonellosis, borrelliosis, typhus, rickettsiosis, and/or the plague.

In one embodiment, the pest is a tick that carries an agent that causes, for example, Lyme disease, meningoencephalitis, Crimean-Congo hemorrhagic fever, tick-borne relapsing fever, Q fever, spotted fever, babesiosis, ehrlichiosis, and/or tularemia.

In one embodiment, pest is a plant-pathogenic bacteria, for example, Pseudomonas (e.g., P. savastanoi, P. syringae pathovars); Ralstonia solanacearum; Agrobacterium (e.g., A. tumefaciens); Xanthomonas (e.g., X. oryzae pv. Oryzae, X. campestris pathovars, X. axonopodis pathovars); Erwinia (e.g., E. amylovora); Xylella (e.g., X. fastidiosa); Dickeya (e.g., D. dadantii and D. solani); Pectobacterium (e.g., P. carotovorum and P. atrosepticum); Clavibacter (e.g., C. michiganensis and C. sepedonicus); Candidatus Liberibacter spp.; Pantoea: Burkholderia; Acidovorax; Streptomyces; Spiroplasma; and/or Phytoplasma; as well as huanglongbing (HLB, citrus greening disease), citrus canker disease, citrus bacterial spot disease, citrus variegated chlorosis, brown rot, citrus root rot, citrus and black spot disease.

In one embodiment, the pest is a plant-pathogenic virus such as, for example, Carlavirus, Abutilon, Hordeivirus, Polyvirus, Mastrevirus, Badnavirus, Reoviridae, Fiivirus, Oryzavirus, Phytoreovirus, Mycoreovirus, Rymovirus, Tritimovirus, Ipomovirus, Bymovirus, Cucumovirus, Luteovirus, Begomovirus, Rhabdoviridae, Tospovirus, Comovirus, Sobemovirus, Nepovirus, Tobravirus, Benyvirus, Furovirus, Pecluvirus, Pomovirus; alfalfa mosaic virus; beet mosaic virus; cassava mosaic virus; cowpea mosaic virus; cucumber mosaic virus; panicum mosaic satellite virus; plum pox virus; squash mosaic virus; tobacco mosaic virus; plant herpesvirus; tulip breaking virus; and zucchini yellow mosaic virus.

In one embodiment, the pest is a plant-pathogenic fungus, mold or mildew, such as, for example, Alternaria spp., Aspergillus spp., Armillaria spp., Botrytis spp. (e.g., B. cinerea), Botryotinia spp. (e.g., B. fuckeliana), Colletotrichum spp. (e.g., C. gloeosporioides), Diplocarpon spp. (e.g., D. rosae), Fusarium spp. (e.g., F. avenaceum, F. bubigeum, F. culmorum, F. graminearum, F. langsethiae, F. oxysporum, F. proliferatmm, F. sporotrichioides, F. poae, F. reseum, F. solani, F. tricinctum, F. verticillioides, F. virguliforme, F. xylariodides), Ganoderma spp. (e.g., G. zonatum), Hemileia spp. (e.g., H. vasatrix), Magnaporthe spp. (e.g., M grisea), Microsphaera spp. (e.g., M. alphitoides), Monilinia spp. (e.g., M. fructicola), Mycosphaerella spp. (e.g., M. fijiensis), Penicillium spp. (e.g., P. expansum, P. digitatum, P. allit), Phakospora spp. (e.g., P. pachyrhizi), Plasmodiophora spp. (e.g., P. brassicae), Podosphaera spp. (e.g., P. macularis), Phytophthora spp. (e.g., P. infestans, P. sojae, P. agathidicida, P. cactorum, P. megakarya), Puccinia spp. (e.g., P. graminis, P. asparagi, P. horiana, P. recondita), Pythium spp. (e.g., P. insidiosum, P. oligandrum, P. nunn, P. periplocum, P. acanthicum), Rhizoctonia spp. (e.g., R. solani), Septoria spp. (e.g., S. lycopersic), Sclerotinia spp. (e.g., S. sclerotiorum), Spongospora spp. (e.g., S. subterranean), Taphrina spp. (e.g., T. deformans), Talaromyces spp. (e.g., T. proteolyticus, T. neofusisporus, T. heineensis, T. mangshanicus), Thanatephorus spp. (e.g., T. cucumeris), Thielaviopsis spp. (e.g., T. basicola), Ustilago spp. (e.g., U. maydis), and/or Verticillium spp. (e.g., V. dahliae, V. alboatrum, V. longisporum, V. nubilum, V. theobromae, V. tricorpus).

In one embodiment, the pest is a nematode or other worm-type pest. Examples include, but are not limited to, Meloidogyne spp. (e.g., M incognita, M javanica, M arenaria M graminicola, M chitwoodi or M hapla); Heterodera spp. (e.g., H. oryzae, H. glycines, H. zeae or H. schachtii); Globodera spp. (e.g., G. pallida or G. rostochiensis); Ditylenchus spp. (e.g., D. dipsaci, D. destructor or D. angustus); Belonolaimus spp.; Rotylenchulus spp. (e.g., R renmformis); Pratylenchus spp. (e.g., P. cofeae, P. goodeyi or P. zeae); Radopholus spp. (e.g., R. similis); Hirschmaniella spp. (e.g., H. oryzae); Aphelenchoides spp. (e.g., A. besseyi); Longidorus spp. (e.g., L. macrosoma); Helicotylenchus spp.; Hoplolaimus spp.; Xphinema spp. (e.g., X. americanum); Paratrichodorus spp. (e.g., P. minor, P. teres); Tylenchorhynchus spp; Mansonella spp. (e.g., M. streptocerca, M. perstans and M. ozzardi); Trichinella, (e.g., T. pseudospiralis, T. native, T. nelsoni, T britovi); Angiostrongylus spp. (e.g., A. cantonensis, A. costaricensis); Toxocara spp.; Gnathostoma spp. (e.g., G. spinigerum, G. hispidum); Trichodorus similis; Dracwwulus medinensis; Loa loa; Criconemoides spp.; Onchocerca volvulu; and Pseudoterranova decipiens.

### Target Plants

As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g. microalga) and a plurality of plant cells that are largely differentiated into a colony (e.g. volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

Example of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis saliva, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Cofea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca saliva, Lathyrus spp., Lens culinaris, Linum usitatissimum, Litchi chinensis, Lotus spp., Lufa acutangula, Lupinus spp., Luula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago saliva, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. saliva, O. latifolia), Panicum miliaceum, Panicum virgatum, Passiflora edulis, Pastinaca saliva, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T. macha, T. sativum, T. monococcum or T. vulgare), Tropaeolum minus, Tropaeoln majus, Vaccinium spp., Vicia spp., Vigna spp., Viola odorata, Vitis spp., Zea mays, Zizaniapalustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine mar), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithit); Bermuda grass (Cynodon spp.); St. Augustine grass (Stenotaphrum secundatum); zoysia grass (Zoysia spp.); Bahia grass (Paspalum notatum); carpet grass (Axonopus afinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

### Growth of Microorganisms According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

The microorganisms of the subject compositions may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid, alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination. Additionally, antifoaming agents may also be added to prevent the formation and/or accumulation of foam when gas is produced during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The biomass content of the fermentation medium (e.g., broth) may be, for example, from 5 g/l to 180 g/l or more or from 10 g/l to 150 g/l. The cell concentration of dried product may be, for example, at least 1×10⁹, 1×10¹⁰, 1×10¹¹, 1×10¹² or 1×10¹³ cells or spores per gram.

The microbial growth by-product produced by microorganisms of interest may be retained in the microorganisms or secreted into the growth medium. The medium may contain compounds that stabilize the activity of microbial growth by-product.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

### Methods of Solid State Fermentation

In preferred embodiments, the subject invention provides methods of cultivating a microorganism and/or a microbial growth by-product using a novel form of solid state fermentation, or matrix fermentation. Advantageously, the cultivation methods can be scaled up or down in size. Most notably, the methods can be scaled to an industrial scale, meaning a scale that is capable of supplying microbe-based products in amounts suitable for commercial applications, e.g., agriculture.

The subject invention does not require fermentation systems having sophisticated aeration systems, mixers, or probes for measuring and/or stabilizing DO, pH and other fermentation parameters.

In preferred embodiments, the method of cultivating a microorganism and/or producing a microbial growth by-product comprises: a) placing a solid substrate, optionally mixed with nutrients to enhance microbial growth, into a container to form a matrix; b) applying an inoculant of a microorganism to the matrix; c) placing the container with the inoculated matrix into an incubation space; and d) incubating the container at a temperature between 25-40° C. for an amount of time to allow the microorganism to grow through the matrix.

In certain embodiments, the solid substrate comprises a plurality of individual solid items, e.g., pieces, morsels, grains or particles. In preferred embodiments, the solid items are foodstuff. The foodstuff can include one or more of, for example, rice, rice husk, rice bran, beans, lentils, legumes, oats and oatmeal, corn and other grains, pasta, wheat bran, flours or meals (e.g., corn flour, corn steep powder, nixtamilized corn flour, partially hydrolyzed corn meal), and/or other similar foodstuff to provide surface area for the microbial culture to grow and/or feed on.

In one embodiment, wherein the matrix comprises pre-made pasta, the pasta can be made from, for example, corn flour, wheat flour, semolina flour, rice flour, quinoa flour, potato flour, soy flour, chickpea flour and/or combinations thereof. Advantageously, the microbes can grow inside the pasta and/or on outside surfaces of the pasta.

In one embodiment, the method of cultivation comprises preparing the container, which can be, e.g., a tray, a metal sheet pan or a steam pan fitted for a standard proofing oven. Preparation can comprise covering the inside of the containers with, for example, foil. Preparation can also comprise sterilizing the containers by, for example, autoclaving them. Lids, as well as silicon bands, can be provided for sealing the containers, if desired.

Next, a matrix is formed by mixing a foodstuff and a liquid medium comprising additional salts and/or nutrients to support microbial growth. The mixture is then spread into the containers and layered to form a matrix with a thickness of approximately 1 to 12 inches, preferably, 1 to 6 inches.

In preferred embodiments, the matrix substrate serves as a three-dimensional scaffold that provides ample surface area on which microbes can grow. In some embodiments, the foodstuff in the matrix can also serve as a source of nutrients for the microbes. Furthermore, the matrix can provide increased access to oxygen supply when a microorganism requires cultivation under aerobic conditions.

In one embodiment, grooves, ridges, channels and/or holes can be formed in the matrix to increase the surface area upon which the microorganisms can grow. This also increases the depth of microbial growth within the substrate and provides enhanced oxygen penetration throughout the culture during aerobic cultivation.

Sterilization of the containers and matrix can be performed after the matrix has been placed into the container. Sterilization can be performed by autoclave or any other means known in the art. In some embodiments, when, for example, pasta is used as the solid substrate, this process can also effectively cook the substrate. To create a completely sterile system, lids and bands can also be sterilized.

In one embodiment, when a flour or a meal is used as the solid substrate, the method can comprise sectioning or chopping the matrix into chunks. Flours and meals can create a denser matrix than foodstuff having larger individual pieces, especially after it has been subjected to sterilization. Thus, breaking up the dense substrate prior to seeding with a microorganism increases the surface area for microbial growth.

After preparation, the matrix in the container can be inoculated with a desired microorganism that is optionally pre-mixed with sterile nutrient medium. Optionally, depending upon the aeration needs of the microorganism being cultivated, the containers can then be sealed with, for example, the lids and bands. When, for example, an anaerobic microbe is being produced, aeration is not needed and the container can be sealed.

The inoculum preferably comprises vegetative cells, spores, conidia, or other propagules of a desired microorganism, which can be cultivated beforehand using any known fermentation method. In one embodiment, inoculation is performed by applying the inoculum uniformly onto the surface of the matrix. The inoculum can be applied via, for example, spraying, sprinkling, pouring, injecting, pipetting or spreading.

The containers with inoculated matrix can then be placed inside an incubation space. In one embodiment, the incubation space is a fermentation reactor. In one embodiment, the fermentation reactor is a proofing oven, such as, for example, a standard proofing oven used in commercial baking. In one embodiment, the incubation space is a thermostable room or enclosure comprising walls, a floor and a ceiling.

Optionally, the incubation space can be equipped with a conveyer system, wherein the inoculated containers move continuously through the space at a speed allowing for culture to grow using, for example, a conveyer belt or a pulley system.

Fermentation parameters within the incubation space can be adjusted based on the desired product to be produced (e.g., the desired microbial growth by-product) and the microorganism being cultivated. Advantageously, in one embodiment, it is not necessary to monitor or stabilize the pH of the culture.

In one embodiment, the incubation space can optionally comprise an aeration system to provide slow motion air supply. The use of an aeration system depends upon the needs of the microorganism being cultivated.

In one embodiment, the use of passive exchange of ambient air can be sufficient to supply the necessary oxygenation to an aerobic culture and to standardize the concentration of air within the incubation space. In one embodiment, this passive air exchange system comprises an inlet, optionally with an air filter, through which ambient air travels into the incubation space, and an outlet, through which air exits the space.

In some embodiments, a vacuum and/or pump system provides air exchange into and out of the incubation space.

In some embodiments, individual containers can comprise inlets and outlets for air exchange. For example, in one embodiment, a container sealed with a lid can comprise an inlet and an outlet fixed to the lid, wherein an air pump supplies slow motion air into the sealed container through tubing attached to the inlet, and air exits the container through tubing attached to the outlet.

The temperature within the incubation space is preferably kept between about 25-40° C. In one embodiment, the temperature is kept at about 25-35° C. In one embodiment, the temperature is kept at about 32-37° C. The exact temperature range will vary depending upon the microorganism being cultivated.

The culture can be incubated for an amount of time that allows for the microorganism to grow and reach a desired concentration. In one embodiment, when the culture is a spore-forming microbe, the incubation time is preferably long enough for the culture to reach 50% to 100% sporulation.

In preferred embodiments, the amount of incubation time is from 1 day to 14 days, more preferably, from 2 days to 10 days.

The containers may be sprayed regularly throughout fermentation (e.g., once a day, once every other day, once per week) with a sterile nutrient medium to increase microbial concentration. In some embodiments, the microorganisms will consume either a portion of, or the entirety of, the matrix substrate throughout fermentation.

The culture and remaining substrate can be harvested from the containers, then blended together to produce a microbial slurry. The microbial slurry can comprise the microbes, their growth by-products, and any remaining nutrients and substrate. The microbial slurry can be processed and further ingredients, e.g., additional nutrients, can be added as deemed necessary for the intended use of the microbe-based product. The concentration of microbes produced according to the subject methods can reach at least 1×10⁸ cells per gram, preferably, from 1×10¹⁰ to 1×10¹² cells, spores or other propagules per gram.

In one embodiment, the microbial slurry is homogenized and dried to produce a dry microbe-based product. Drying can be performed using standard methods in the art, including, for example, spray drying or lyophilization.

In one embodiment, the microbial slurry can be utilized directly, without drying or processing. In another embodiment, the microbial slurry can be mixed with water to form a liquid microbe-based product.

In some embodiments, the various formulations of microbe-based product produced according to the subject methods can be stored prior to their use.

Advantageously, the method does not require complicated equipment or high energy consumption. The microorganisms of interest can be cultivated at small or large scale on site and utilized, even being still-mixed with their media. Similarly, the microbial metabolites can also be produced at large quantities at the site of need.

Advantageously, the microbe-based products can be produced in remote locations. The microbe growth facilities may operate off the grid by utilizing, for example, solar, wind and/or hydroelectric power.

### Thermostable Enclosure System

In one embodiment, the fermentation reactor utilized in the subject methods can comprise a large, moisture-sealed, thermostable enclosed space, having four vertical walls, a floor and a ceiling. The walls can optionally comprise one or more windows and/or doors. This thermostable enclosure can replicate the environment that would exist in, for example, a proofing oven fermentation reactor, yet on a much larger scale.

In one embodiment, the thermostable enclosure is fixed onto a portable platform, such as a trailer with wheels.

In one embodiment, the interior of the thermostable enclosure comprises a plurality of horizontal surfaces, upon which the containers with inoculated matrix substrate can be placed.

In one embodiment, the surfaces are in the form of shelves. The shelves can be fixed onto the walls of the enclosure. Shelving units can also be suspended from the ceiling and/or fixed to the floor.

In one embodiment, the thermostable enclosure comprises a plurality of metal sheet pan racks. The sheet pan racks preferably comprise horizontal surfaces in the form of a plurality of slides for holding trays with inoculated matrix substrate. In one embodiment, the racks are portable, for example, fitted with wheels.

In one embodiment, the pan rack can hold from 10 to 50 trays. Preferably, the slides are spaced at least 3 inches apart from one another to allow for optimal air circulation between each tray when growing aerobic microbes.

In one embodiment, the ceiling of the enclosure can optionally be accommodated to allow for air flow, for example, with ceiling vents and/or air filters. Furthermore, the ceiling and walls can be fitted with UV lights to aid in sterilization of air and other surfaces within the system. Advantageously, the use of metal trays and metal pan racks enhances reflection of the UV light for increased UV sterilization.

In one embodiment, the thermostable enclosure can be equipped with standard temperature controls.

The dimensions of the thermostable enclosure can be customized based on various factors, such as, for example, the location of the enclosure and the number of containers to be placed therein. In one embodiment, the height of the ceiling is at least 8 feet, and the area of the floor is at least 80 square feet.

In one embodiment, the method of cultivating a microorganism and/or producing a microbial growth by-product comprises: a) placing a solid substrate, optionally mixed with nutrients to enhance microbial growth, into a container to form a matrix; b) applying an inoculant of a microorganism to the matrix; c) placing the container with inoculated matrix onto a horizontal surface, wherein the surface is inside a thermostable enclosure; and d) incubating the container with the inoculated matrix at a temperature between 25-40° C. for an amount of time to allow the microorganism to grow through the matrix.

In certain embodiments, the container is a sheet pan or tray, and the horizontal surface is a slide in a sheet pan rack. The tray can be places on the slides of the pan rack, along with a plurality of other inoculated trays. In one embodiment, a plurality of sheet pan racks filled with trays is used inside the thermostable enclosure.

### Preparation of Microbe-Based Products

In certain embodiments, the biopesticide composition is a “microbe-based product,” which is a product to be applied in practice to achieve a desired result. The microbe-based product can be simply a microbe-based composition harvested from the microbe cultivation process, or individual components thereof, such as supernatant. Alternatively, the microbe-based product may comprise further ingredients that have been added. These additional ingredients can include, for example, stabilizers, buffers, appropriate carriers, such as water, salt solutions, or any other appropriate carriers, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the substrate containing the microorganism and/or the microbial metabolites produced by the microorganism and/or any residual nutrients. Upon harvesting of the solid substrate, microbe, and/or by-products, the product can be homogenized, and optionally, dissolved in water, e.g., in a storage tank. In some embodiments, prior to dissolving in water, the product can be dried using, for example, spray drying or lyophilization. The dried product can also be stored.

The product of fermentation may be used directly without extraction or purification. If desired, extraction and purification can be achieved using standard extraction methods or techniques known to those skilled in the art.

The microorganisms in the microbe-based product may be in an active or inactive form. In some embodiments, the microorganisms have sporulated or are in spore form. The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

In one embodiment, the microbe-based product can comprise at least 1×10⁸ to 1×10¹² cells, spores or other propagules per gram. In preferred embodiments, the product comprises at least 1×10¹⁰ cells, spores or other propagules per gram.

The dried product and/or liquid product containing the dissolved culture can be transferred to the site of application via, for example, tanker for immediate use. Additional nutrients and additives can be included as well.

In other embodiments, the composition (in the form of a dried product or in dissolved liquid form) can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 gallon to 1,000 gallons or more. In certain embodiments the containers are 2 gallons, 5 gallons, 25 gallons, or larger.

Upon harvesting the microbe-based composition from the reactors, further components can be added as the harvested product is processed and/or placed into containers for storage and/or transport. The additives can be, for example, buffers, carriers, other microbe-based compositions produced at the same or different facility, viscosity modifiers, preservatives, nutrients for microbe growth, tracking agents, pesticides, and other ingredients specific for an intended use.

Advantageously, in accordance with the subject invention, the microbe-based product may comprise the substrate in which the microbes were grown. The amount of biomass in the product, by weight, may be, for example, anywhere from 0% to 100% inclusive of all percentages therebetween.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 50° C. On the other hand, a biosurfactant composition can typically be stored at ambient temperatures.

### Local Production of Microbe-Based Products

In certain embodiments of the subject invention, a microbe growth facility produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a citrus grove). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This allows for a scaled-down bioreactor (e.g., smaller fermentation vessel, smaller supplies of starter material, nutrients and pH control agents), which makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used (e.g., a citrus grove), for example, within 300 miles, 200 miles, or even within 100 miles. Advantageously, this allows for the compositions to be tailored for use at a specified location. The formula and potency of microbe-based compositions can be customized for specific local conditions at the time of application, such as, for example, which soil type, plant and/or crop is being treated; what season, climate and/or time of year it is when a composition is being applied, and what mode and/or rate of application is being utilized.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

The cultivation time for the individual vessels may be, for example, from 1 to 7 days or longer. The cultivation product can be harvested in any of a number of different ways.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention. Numerous changes and modifications can be made with respect to the invention.

### Example 1—Growth of Metarhizium Anisoplae Using Solid-State Fermentation

Metarhizium anisopliae was grown by solid-state fermentation using a medium comprising a mixture of rice bran and rice husk with initial water content fixed at a value of about 50%. The medium was spread into metal trays fitted for a standard proofing oven (i.e., used by commercial bakers). Fermentation was then performed in a proofing oven at a temperature of 27±1° C. Fermentation time was 12-14 days.

### Example 2—Growth of Beauveria Bassiana Using Solid-State Fermentation

A seeding culture of Beauveria bassiana with concentration of 1×10⁷ conidia/g was grown for two days in a 3% corn meal, 2% rice bran, and 2% corn steep powder medium.

The seed culture was added to a wet rice medium (polished white rice, 40% moisture content), with the amount of inoculum equaling 10% of the total amount of medium. The culture was grown in a polyethylene bag.

Using these optimal conditions, 4.05 grams of conidia/100 grams dry rice were obtained after 14 days of cultivation at 25° C.

1. A biopesticide composition comprising a beneficial microorganism and/or growth by-products thereof, chitinase and/or a chitinase inducer, an abrasive substance, and a hemolymph anticoagulant, wherein the microorganism is selected from Trichoderma, Debaryomyces, Pichia, Wickerhamomyces, Meyerozyma, Bacillus, myxobacteria, Pseudomonas, Azotobacter, and species of entomopathogenic fungi.

2. The biopesticide composition of claim 1, comprising at least one species of entomopathogenic fungus.

3. The biopesticide composition of claim 3, wherein the species of entomopathogenic fungus is a member of Metarhizium, Beauveria, Cordyceps, Entomophaga, Entomophthora, Hirsutella, Isaria (Paecilomyces), Lecanicillium, Nomuraea, Pandora, Purpureocillium, or Zoopththora.

4. The biopesticide composition of claim 4, comprising Metarhizium anisopliae.

5. The biopesticide composition of claim 1, wherein the abrasive substance is diatomaceous earth and/or pumice powder.

6. The biopesticide composition of claim 1, wherein the hemolymph anticoagulant is selected from ascorbic acid and phenylthiourea.

7. The biopesticide composition of claim 1, wherein the one or more growth by-products are biosurfactants selected from glycolipids, lipopeptides, fatty acid ester compounds, fatty acid ether compounds, flavolipids, phospholipids, lipoproteins, lipopolysaccharide-protein complexes, and polysaccharide-protein-fatty acid complexes.

8. The biopesticide composition of claim 8, wherein the biosurfactants are sophorolipids and/or rhamnolipids.

9. A method for controlling a pest, the method comprising contacting a biopesticide composition comprising a beneficial microorganism and/or a growth by-product thereof, chitinase and/or a chitinase inducer, an abrasive substance, and a hemolymph anticoagulant, with the pest,
wherein the microorganism is selected from Trichoderma, Debaryomyces, Pichia, Wickerhamomyces, Meyerozyma, Bacillus, myxobacteria, Pseudomonas, Azotobacter, and species of entomopathogenic fungi.

10. The method of claim 9, wherein the pest is an arthropod or a nematode.

11. The method of claim 9, wherein the pest is a disease vector.

12. The method of claim 9, wherein the biopesticide composition comprises at least one species of entomopathogenic fungus.

13. The method of claim 9, wherein the species of entomopathogenic fungus is a member of Metarhizium, Beauveria, Cordyceps, Entomophaga, Entomophthora, Hirsutella, Isaria (Paecilomyces), Lecanicillium, Nomuraea, Pandora, Purpureocillium, or Zoopththora.

14. The method of claim 13, wherein the species of entomopathogenic fungus is Metarhizium anisopliae.

15. The method of claim 9, wherein the abrasive substance is diatomaceous earth and/or pumice powder.

16. The method of claim 9, wherein the hemolymph anticoagulant is selected from ascorbic acid and phenylthiourea.

17. The method of claim 9, wherein the growth by-products comprise a biosurfactant.

18. The method of claim 17, wherein the biosurfactant is a sophorolipid or a rhamnolipid.

19. The method of claim 9, wherein contacting the biopesticide composition with the one or more pests comprises applying the composition directly to the pest via spraying and/or fogging.

20. The method of claim 9, wherein contacting the biopesticide composition with the one or more pests comprises applying the composition to a surface upon which the pest traverses, rests, mates, lays eggs and/or feeds.

21. The method of claim 20, wherein the surface is a soil, a plant, or a plant part.

22. (canceled)

23. The method of claim 9, wherein damage to, and disease in, plants caused by a pest is inhibited, prevented and/or reduced.

24. The method of claim 9, wherein contacting the pesticidal composition with the pest comprises applying the composition to an insect trap having a chemical attractant, pheromone and/or visual lure therein.
